(19) United States
(12) Patent Application Publication
(10) Pub. No.: US 2006/0164544 A1
(43) Pub. Date: Jul. 27, 2006

(54) Apparatus and method for scrambling, descrambling and secured distribution of audiovisual sequences stemming from DCT-based video coders

(75) Inventors: Daniel Lecomte, Paris (FR); Daniela Parayre-Mitzova, Paris (FR); Jerome Caporossi, Bourg-la-Reine (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Medialive, a corporation of France, Paris (FR)

(21) Appl. No.: 11/387,628

(22) Filed: Mar. 23, 2006

Related U.S. Application Data
(63) Continuation of application No. PCT/FR04/50462, filed on Sep. 24, 2004.

(30) Foreign Application Priority Data
Sep. 24, 2003 (FR) 03/50597

(51) Int. Cl. H04N 7/12

(52) U.S. Cl. 348/390.1

(57) ABSTRACT

A process and system for secured distribution of video sequences in accordance with the digital stream format based on a DCT transformation constituted of frames including blocks with a fixed or variable size, at least a part of which blocks is calculated with the aid of temporal prediction and spatial prediction optimized from adjacent blocks, in which the prediction mode, cutting into blocks and decoding and filtering parameters for the display are indicted in the binary stream, wherein an analysis of the stream is made prior to transmission to client equipment to generate a modified main stream with the format of the original stream, and with complementary information of any format comprising the digital information suitable for allowing the reconstruction of these modified frames, then the modified main stream and the complementary information are transmitted separately during the distribution phase from a server to the equipment of an addressee.

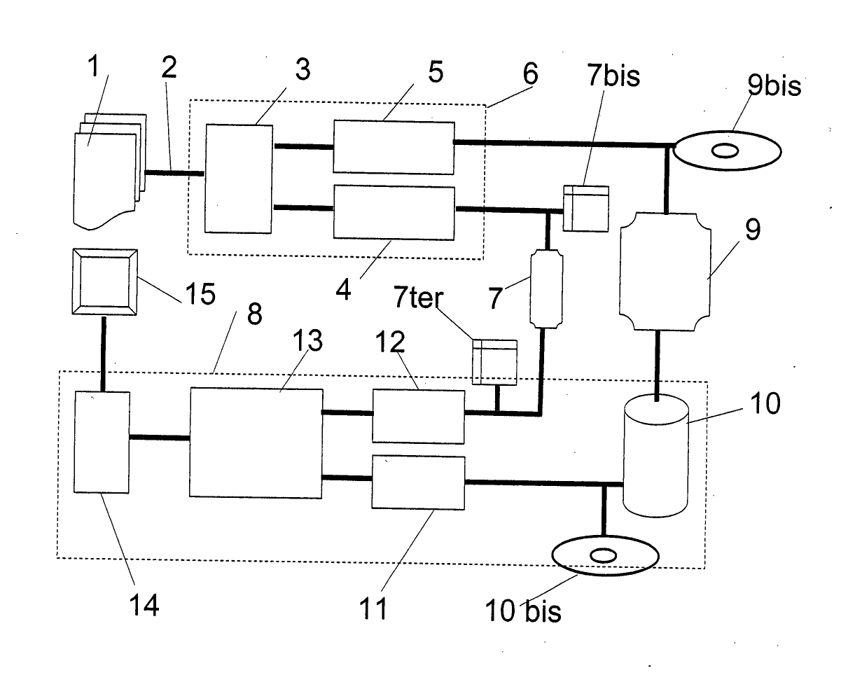

### RELATED APPLICATION

This is a continuation of International Application No. PCT/FR2004/050462, with an international filing date of Sep. 24, 2004 (WO 2005/032135, published Apr. 7, 2005), which is based on French Patent Application No. 03/50597, filed Sep. 24, 2003.

### FIELD OF THE DISCLOSURE

This disclosure generally relates to the area of processing sequences of images encoded with the aid of video coders based on the DCT (“Discrete Cosine Transform”) transformation and on techniques of spatial and temporal prediction.

### BACKGROUND

It is possible with the current solutions to transmit films and audiovisual programs in digital form via broadcasting networks of the microwave (hertzian), cable, satellite, etc. type or via telecommunication networks of the DSL (Digital Subscriber Line) or BLR (local radio loop) type or via DAB networks (Digital Audio Broadcasting) or the like. They are frequently encrypted or scrambled by various known means to avoid pirating of works broadcast in this manner.

US 2001/0053222 A1 discloses a process and system for the protection of video streams encoded according to the MPEG-4 norm. The audiovisual stream is composed of several audio and video objects managed by a scenic composition. One of the objects of the video stream is encrypted with the aid of a key that is generated in four encryption stages and that can be periodically renewed. The protected objects are video objects. The encrypted object is multiplexed with the other objects and the entire stream is sent to the user. The MPEG-4 stream is recomposed on the addressee's equipment by the decryption module that reconstitutes the original video stream from the encrypted video stream and by regenerating the encryption key from previously sent encryption information and information contained in the encrypted stream. Given the fact that the protected content of the video objects is located in the stream sent to the user, an ill-disposed user who finds the encryption keys is able to decrypt the protected content and view it or broadcast it.

WO 01/69354 A3 discloses protection of a digital product (software or audio or video content) by decomposing it into at least two streams. The first stream is transmitted to client equipment by a physical means such as a CE-ROM, a disk or even by downloading. The second stream is transformed in such a manner that it can only be exploited by the client terminal concerned and is then transmitted entirely by the same process or by a telecommunication network to the client terminal. The client terminal receiving the two streams can modify the first stream as a function of a key transmitted by the server such that the first stream is compatible with the second stream received. These two streams are recombined together to restore a binary stream modified “in substance” equivalent to the original stream, but different in terms of configuration and adequate for the client equipment. In this manner, that system ensures that the stream to be transmitted is adapted to the client's apparatus and can only be used on the latter.

However, there is no exemplary embodiment of the processing carried out on the two streams. Furthermore, no digital video or audiovisual format is cited. Thus, separation of the stream into two parts is carried out and the two parts are modified before being recombined. Conformity with the original stream of either of the two parts initially separated is neither described or suggested. After reconstitution, the stored file is modified, operationally different but substantially identical to the original file, given that it is adapted to the addressee's equipment and solely for that equipment, that the reconstituted stream is not the same as the original stream and the process therefore produces a loss. The protection used is encryption with keys and thus all the information and initially contained in the original stream remains inside the two components transmitted to the user. The two encrypted components are sent in their entirety via two different paths and in two stages. After reception of the two encrypted components, the user is in possession of the entirety of the elements constituting the original stream. Therefore, that disclosure does not entirely respond to the problem of securement: in fact, an ill-disposed person who discovers the encryption keys can gain possession of the original stream since the entire content of the initial stream is present in the two encrypted parts.

XP000997705 discloses protection of video streams stemming from DCT-based video encoders. To reduce the resources for encryption, a process for partial encryption of data based on the property of the partitioning of data “data partitioning” (that consists in encoding differently the most important parts of the stream while leaving the two parts physically in the same stream) is disclosed. Encryption is carried out using the filling bits “padding” and is applied to the I images and the intra blocks of the P images. It also describes variable encryption of the transmission rate. The first N DCT coefficients are selected and encrypted. Varying N affects the transmission rate of the protected stream and the resources for encryption are managed in this manner. An encryption is also performed on the movement vectors. A partial and transparent encryption is also described for streams characterized by a temporal and spatial scalability. The partial encryption is the encryption applied to the base layer or the first enhancement layers.

However, it responds only partially to the problem of security because it proposes well known encryption techniques that permute (interchange, swap) the data in the stream or add encryption keys, but in this case all the data describing the digital stream are contained in the stream sent to the user.

Also, encrypting the entire video stream causes a significant increase in the size of the protected stream (more than 50%). In addition, in certain configurations of encryption, the ratio of increase in size/efficiency of the protection/visual degradation is not optimal.

“Protecting VoD the Easier Way,” Griwodz et al., Proceedings of the ACM Multi-media 98. MM'98, Bristol, Sep. 12-16, 1998, ACM, describes a process for distribution of protected multimedia content whose access is controlled and traceability ensured. The initial stream is deliberately corrupted by a modification of certain bytes in the stream, which bytes are selected according to a predefined law, and a signal permitting its reconstruction is not transmitted to the client until the moment of viewing content. That signal, transmitted in encrypted form, contains the bytes read in the original stream before their corruption. When a client connects to a server and wishes to access a protected content by accepting the conditions (payment, subscribing to a subscription), a secure point-to-point connection is established between the client and a unicast server. At first, a key is communicated to the client: the key will allow the client to recalculate emplacement of the corrupted bites in the protected stream. Then, the signal containing the original bytes is sent after encryption. Finding the position of the corrupted bytes and decrypting the information contained in the signal reconstructs the original stream during viewing via a system of synchronization between the signal and the protected stream. As emplacement of the corrupted bytes is calculated from a decryption key, that system does not entirely respond to the problem of securing audiovisual content. Moreover, conformity of the protected stream relative to the standard of the original stream is not assured.

FR 2 835 386 discloses secure broadcasting, conditional access, controlled viewing, private copy and management of the rights of audiovisual contents of the MPEG-4 type. It discloses video sequences encoded according to a nominal stream format constituted of data representing a succession of audiovisual scenes composed by several independent audiovisual objects hierarchized and organized according to a script describing their spatial relationships (intra image relationship) and temporal relationships (inter images relationships). This format is the one described, e.g., in part 2 of the MPEG-4 standard. It modifies the information describing the spatial and temporal relationships between the different audiovisual objects.

In the document “A new video encryption technique based on modification of VLC tables, disarrangement of RLC indices, randomized bit-flipping, and randomized bit-insertion,” Y. M. Chen and S. J. Wang, XP002276517 discloses a method of protecting a compressed video stream that is based primarily on modifications of the VLC code words. It is applied in the case of a natural video encoded according to the MPEG-4 standard (MPEG-4 part 2). The basic idea is to permute the nodes of the trees of VLC codings that allow a code word to be associated with each symbol: without knowledge of the manner with which the nodes of the tree were permuted (coded according to 16 permutation keys), it is very difficult to reconstruct the sequence of original symbols in order to access an unscrambled content. The authors describe two novel operations that are combined with the preceding one to improve the security of the process:
Certain bits of the code words can be inverted and the inversion is indicated by the value of a marker inserted in the bitstream at a position determined by a key: without the key permitting this marker to be localized in order to know if it is necessary to re-invet or not re-invert the bits of a group of code words is difficult to access an unscrambled content.
The symbols coded by VLC are RLC (Run Length Coding) indices: these RLC indices undergo rearrangements according to predefined rules and sub-keys generated from a primary key 16 bytes long.

As the security is based entirely on the secret of the decryption keys, it does not respond entirely to the problem of a robust securing of audiovisual contents.
The problem of securing multimedia data streams with the aid of standard cryptographic algorithms (permutation of bits, DES or AES encryption) while retaining the syntax of the stream and controlling the increase of the size of the encrypted stream has been addressed by “Communication-Friendly Encryption of Multimedia,” M. Wu and Y. Mao. It discloses three techniques.
The encryption of parts of a stream that correspond only to the “raw” compressed data. That method induces a slight inflation of the protected stream and the conformity of the stream is not preserved.
The indexes of the original VLC code words are encrypted and generate a new sequence of VLC code words. Inflation of the stream is inevitable even if the authors provide a solution for controlling it, and a compromise must then be made between security and the increase.
A method of encrypting the bit planes (permutations signed with the aid of keys) permits compatibility with FGS (Fine Granularity Scalability) streams, but also induces an increase in the transmission rate of the protected stream.

Since security is entirely based on the secret of the decryption keys, it therefore does not entirely answer the problem of robust security of audiovisual contents.

“A format-compliant configurable encryption framework for access control of video,” W. Jen et al., IEEE Transactions on Circuits and Systems for Video Technology, vol. 16, No. 6, Jun. 2002 discloses two methods for protecting audiovisual streams, methods whose chief property is to preserve conformity of protected streams relative to the native standard or format.
The first method consists of replacing a series of VLC (Variable Length Coding) code words with another valid series of VLC code words, which latter is generated from the first one in accordance with an operation of symmetric encryption (DES, AES) performed on the indexes marking (identifying) the position of each codeword present in the VLC decoding table. The original data can be found again from the encrypted data and the key by performing the inverse operations of decryptions of the indexes.
The second method is based on random permutations (shuffling) of subsets of code words while preserving to the extent possible the conformity of the auto visual stream.

Once again, since the security is entirely based on the secret of the decryption keys, it therefore does not entirely answer the problem of a robust security of audiovisual contents.

### SUMMARY

This invention relates to a process for secured distribution of video sequences in accordance with a digital stream format based on a DCT transformation having frames including blocks with a fixed or variable size, wherein at least a part of the blocks is calculated with temporal prediction and spatial prediction determined from adjacent blocks, in which a prediction mode, cutting into blocks and decoding and filtering parameters for display are identified in a binary stream, including analyzing the stream prior to transmission to client equipment to generate a modified main stream with a format of the original stream, and complementary information of any format including digital information suitable for allowing reconstruction of modified frames, and transmitting the modified main stream and complementary information separately during a distribution phase from a server to equipment of an addressee.

This invention also relates to a system for producing a video stream including at least one multimedia server containing original video sequences, a device for analyzing a video stream, a device for separating the original video stream into a modified main stream and complementary information as a function of an analysis, at least one telecommunication network for transmission and at least one device in the addressee's equipment for reconstruction of the video stream as a function of the modified main stream and the complementary information.

### BRIEF DESCRIPTION OF THE DRAWINGS

The Drawing is a schematic representation of a portion of a system that scrambles and descrambles transmissions.

### DETAILED DESCRIPTION

Contrary to the majority of the “classic” protection methods, the process disclosed herein is lossless and seeks a high level of protection while reducing the volume of information necessary for decoding.

The protection is based on the principle of deleting and replacing certain information coding the original visual signal by any method, e.g.: substitution, modification, permutation or shifting of information. This protection is also based on a knowledge of the structure of the binary stream at the output of the visual encoder based on a DCT transformation and a spatial and temporal prediction.

This disclosure furnishes a process and system permitting the visual scrambling of a video sequence and recomposing (descrambling) of its original contents from a digital video stream obtained by an encoding based on a DCT transform and on techniques of spatial and temporal prediction for calculating coefficients coding the visual elements.

The disclosure concerns the general principle of a process for securing an audiovisual stream. It authorizes video services on demand and a la carte via broadcasting networks and authorizes local recording in the digital decoding box of the user as well as the direct viewing of television channels. It extracts and permanently saves, outside of the user's dwelling and in the broadcasting and transmitting network, a part of the audiovisual program recorded at the client's or directly broadcast, which part is of primary importance for viewing the audiovisual program on a television or monitor-type screen, but which has a very small volume relative to the total volume of the digital audiovisual program recorded at the user's or received in real time. The lacking part is transmitted via the broadcasting or transmitting network at the moment of the viewing of the audiovisual program.

Since the digital stream is separated into two parts, the largest part of the modified audiovisual stream, called “modified main stream,” is therefore transmitted via a classic broad-casting network whereas the lacking part, called “complementary information,” is sent on demand via a narrow-band telecommunication network such as classic telephone networks or cellular networks of the GSM, GPRS or UMTS type or by using a small part of a network of the DSL or BLR type or by using a subset of the bandwidth shared on a cable network, or also via a physical support such as a memory card or any other support. However, the two networks can be combined while keeping the two transmission paths separate. The audiovisual stream is reconstituted on the addressee's equipment (decoder) by a synthesis module from the modified main stream and the complementary information.

The disclosure relates more particularly to a device capable of securely transmitting a set of video streams with a high visual quality to a viewing screen of the television screen type and/or for being recorded on the hard disk or on any other recording support of a box connecting the telecommunication network to a viewing screen such as television screen or a personal computer monitor while preserving the audiovisual quality, but avoiding fraudulent use such as the possibility of making pirated copies of films or audiovisual programs recorded on the hard disk or on any other recording support of the decoder box. The disclosure also relates to a client-server system and the synchronization mechanism between the server supplying the stream that allows viewing the secure digital video film and between the client who reads and displays the digital audiovisual stream.

The disclosure includes a protection system comprising an analysis-scrambling and descrambling module based on a digital format stemming from a video encoding based on transformations in DCT. The analysis and scrambling module is based on substitution by “decoys” or the modification of part of the coefficients stemming from the DCT transformation and/or indicating the modes of spatial and temporal predictions used and/or the residual coefficients obtained with the aid of spatial and temporal predictions before or after the DCT transformation. The fact of having removed and substituted part of the original data from the initial video stream during generation of the modified main stream does not allow for restoration of the original stream only from the data of the modified main stream.

Several non-limiting examples of the scrambling process are illustrated based on characteristics of the digital stream based on the DCT transformation and on the protection optimized for the compression of visual elements.

According to a general aspect, the process relates to the secured distribution of video sequences in accordance with the digital stream format based on a DCT transformation constituted of frames comprising blocks with a fixed or variable size, at least a part of which blocks is calculated with the aid of temporal prediction and spatial prediction optimized from adjacent blocks, in which the prediction mode, cutting into blocks and decoding and filtering parameters for the display are indicted in the binary stream, characterized in that an analysis of the stream is made prior to the transmission to the client equipment to generate a modified main stream with the format of the original stream, and with complementary information of any format comprising the digital information suitable for allowing reconstruction of the modified frames. Then, the modified main stream and the complementary information are transmitted separately during the distribution phase from a server to the equipment of an addressee.

The process can have various additional characteristics:
It is applied to streams in conformity with the H.264 norm (or MPEG-4 part 10 or AVC or JVT).
Scrambling is performed for a stream in conformity with the H.264 standard by modifying the indication of the spatial prediction modes of the intra blocks of I and/or SI frames.
Scrambling is performed for frames I, P and B by modifying the value of the DC and AC coefficients calculated from residues of a prediction prior to the entropic coding.
Scrambling is performed for frames I, P and B by modifying the value of the DC and AC coefficients calculated from residues of a prediction after the entropic coding.
Scrambling is performed for the P and B frames by modifying the indication for the partitions of macroblocks.
Scrambling is performed by modifying the index of reference images relative to the calculation of movement vectors.
Scrambling is performed by modifying the steps of quantifications transmitted in the stream and used for the decoding.
Scrambling is performed by modifying the parameters transmitted in the stream and used for the decoding and for the enhancement filter.
Scrambling is performed by modifying values stemming from an entropic encoding in the binary stream and the original value extracted is replaced by a random or calculated value of the same size.
It is applied to streams in conformity with the MPEG-4 norm, part 2 visual.
Scrambling is performed by modifying the predicted DC and AC coefficients of the Intra blocks.
Scrambling is performed by modifying the quantification steps transmitted in the stream and used for the decoding and the enhancement filter.
Scrambling generates a modified main stream whose size or throughput rate is identical to the size or to the throughput rate of the original stream.
A synthesis of a nominal format stream is calculated on the addressee's equipment as a function of this modified main stream and of this complementary information.
Synthesis of the stream calculated on the addressee's equipment produces a stream strictly identical to the original stream.

The complementary information may be encrypted with one or several known elements of only the addressed user in order to prevent its being used by a third user. The complementary information encrypted with one or several elements of the addressed user is advantageously stored temporarily in a secure or non-secure memory (card, hard disk, removable hard disk, CD-ROM) to allow its being used by the addressed user in a non-connected mode.

The disclosure also relates to a system for producing a video stream comprising at least one multimedia server containing the original video sequences, a device for analyzing a video stream, a device for separating the original video stream into a modified main stream and into complementary information as a function of the analysis, at least one telecommunication network for the transmission and at least one device in the addressee's equipment for reconstruction of the video stream as a function of the modified main stream and the complementary information.

The disclosure will be better understood from a reading of the following description of a non-limiting example referring to the figure, that describes the architecture of a system for implementing aspects of the disclosed process.

Protection of video streams is worked out based on the structure of binary streams and their characteristics due to encoding based on the DCT transformation and optimized protection of visual elements. We illustrate the process with the aid of an example applied for the protection of streams stemming from an H264 encoder.

A digital video H264 (or JVT, AVC or MPEG-4, part 10) is generally constituted of sequences of images (or planes or frames) grouped in groups of images (a group of images is the set of images comprise between two successive I images). An image can be of the I type (Intra), P (Predictive), B (Bidirectional), SI (Switching Intra) or SP (Switching Predictive).

The I images are reference images. They are coded independently of the other images and, therefore, have an elevated size and contain no information about the movement. A prediction of the “intra” type (relative solely to the image itself and exploiting the spatial redundancies in the image) is used to reduce their size. As for the P and B images, they are based on an “inter” prediction mode, that is to say, relative to other images of the stream (use of “movement vectors,” exploitation of temporal redundancies between the images). The P images are images predicted from previously encoded images (I or P) by vectors of movements in a single direction called “forward.” The B images are called “bidirectional” and connected to the I and/or P images preceding them or following them by vectors of movements in the two temporal directions (forward and backward). The movement vectors represent bidimensional vectors used for compensation of movements that procure the difference of coordinates between a part of the current image and a part of the reference image. The SI and SP image are images that allow the passing of a coded stream at a given transmission rate to the same stream with the identical content coded at another transmission rate. They are coded respectively as I or P images.

An image or a frame is constituted of macroblocks, that can be constituted themselves of blocks, containing elements describing the content of the video stream, e.g., the DC coefficients, stemming from a frequency DCT transformation and relative to the fundamental, that is, to the average value of the coefficients of a block, or the AC coefficients, relative to the higher frequencies. The AC coefficients are coded in “run” and “level.” The “runs” are the number of zeros between two non-zero AC coefficients and the “levels” are the value of the non-zero AC coefficients. Each block is coded by associating the DCT coefficients with the movement vectors for the inter prediction (blocks P, B and SP) or the prediction modes for the intra prediction (blocks I and SI).

After an analysis of the structure of a stream in conformity with the H264 standard, the analysis and scrambling module in conformity with the invention carries out modifications (by permutation and/or substitution) of a subset of DCT coefficients and intra prediction modes, for example. These modifications introduce a visually perceptible degradation (scrambling) of the video sequence decoded from the modified stream. It is possible, as a function of the manner in which the modification of the predictions is carried out, to control the spatial and/or temporal extent of the scrambling as well as the intensity of the degradation due to the scrambling.

An example of scrambling as a modification of the Intra prediction modes of the I images by replacement of the elements of the intra prediction modes (fields prev_intra4×4_pred_mode_flag, rem_intra4×4_pred_mode, intra_chroma_pred_mode) with random values (comprise between 0 and 8 or 0 and 7) in such a manner that the modified stream is still compatible with the H264 norm. This modification of the stream entails a rather significant visual degradation of the video. The blocks calculated in the intra images no longer correspond to their to values. Furthermore, the degradation is propagated from block to block since each block is predicted from the previously encoded/decoded blocks. Therefore, images are obtained with zones that are more degraded at the bottom right. This characteristic/feature of the propagation of the degradation is used for optimizing the deterioration of the image in such a manner as to have a significant visual impact with a minimum of values to be modified.

Another example of scrambling comprises in modifying the values of the residues of each block of the I, P or B images after calculation of the intra or inter prediction, calculation of the DCT and quantification, and before the calculation of the entropic coding (CABAC (Context Adapted Binary Arithmetic Coder) or UVLC (Universal Variable Length Code) or CALVC (Context Adapted Variable Length Code)). The DC coefficients are modified and the “run level” of the AC coefficients are replaced by random or inverted values. This modification is advantageously realized with a partial decoding of the binary stream. The visual degradation effect obtained is less significant than that obtained by modification of the Intra prediction modes. In fact, the DC and AC coefficients only represent residual information (the most significant part of the information is coded by the intra or inter prediction mode). However, this type of modifycation is especially interesting for being used as a complement to a changing of the intra prediction modes: the result obtained is a very strong visual degradation.

It is advantageous to directly modify the portions of the binary stream corresponding to the AC and DC coefficients after the binary arithmetic coding adaptable to the context (CABAC, i.e., Context Adapted Binary Arithmetic Coder). Modifying a single byte of the binary chain (at the start of the chain, for example) affects the rest of the data and this modification then brings about a desynchronization of the arithmetic decoder, resulting in erroneous decoded values. The visual impact of the modification performed is very strong and the original content of the image is completely destroyed. Following the modification of a single byte, even of several correctly targeted bits to visually degrade and preserve the conformity of the stream, e.g., those corresponding to the AC coefficient of a block situated at the top left of the image, nothing visually coherent is distinguished any longer. In fact, the contexts of the arithmetic decoder and their updating are modified as a result and the values following the modification will be decoded with erroneous values.

A considerable visual scrambling is advantageously obtained by modifying the partitions of macroblocks in the P or B frames. In the P or B images, the macroblocks have the possibility of being cut into blocks of different sizes and shapes to increase the position of the inter prediction. The appearance of the stream is degraded by modifying the shape and/or the size of these blocks (fields mb_type and sub_mb_type of the macroblocks of the P and B slices (wafers)) while retaining the same number of blocks as in the original stream (there will be as many (pairs of) movement vectors in the stream as blocks). The movement vectors will then point to zones that do not correspond to the desired zones (larger and offset zones), thus causing visual incoherencies.

This modification is carried out, e.g., on 4×8 and 8×4 subpartitions of the 8×8 blocks (sub_mb_type). Visual deformation of the stream is amplified more and more at each image (P or B). The less I images there are in the video stream the greater the efficiency of the scrambling (scrambled blocks transmitted by the movement vectors). Furthermore, in the majority of the coding algorithms, the partitions in subblocks represent the zones containing details. The latter are therefore scrambled more than the smooth zones, which renders the visual degradations more effective.

Another scrambling possibly is modification of reference images relative to the calculation of movement vectors. The movement vectors can reference zones situated up to five reference images (I or P) previously or subsequently encoded. This concerns modifying the index of the reference image so that the zone pointed by the movement vector is no longer coherent.

Modification of the quantification steps transmitted in the stream (fields pic_init_qp_minus26, slice_qp_delta, mb_qp_delta) is advantageously carried out so that the matrices of inverse quantification used in the decoding are erroneous, with a strong degradation as the result.

Another manner of altering the visual quality of the stream is the modification or substitution of parameters for the configuration of the enhancement filters (filters that reduce the effect of blocks) during decoding. The enhancement filters of the image are parameterized with the aid of data present in the slice (wafer) heading (fields slice_alpha_c0_offset_div2 and slice_beta_offset_div2). Modifying these parameters alters the aspect of the reconstituted stream. The images obtained in this manner are modified relative to the original stream, but do not really scramble the video. Only the quality of the stream is affected, but the video content remains largely visible and this modification is used in combination with the previously cited modifications.

Another example of application is the scrambling of video stream stemming from an encoding with the MPEG-4, part 2 Visual norm similar to the digital format described above.

Substitution of the residues of the predicted DC and AC coefficients of the Intra blocks at the level of the binary stream directly with random values of the same size brings about visual incoherencies.

The modification is advantageously carried out after the entropic encoder, that is the entropic encoder of Huffman, in this instance. Likewise, the predicted macroblocks have the possibility of having different quantification steps and during the reconstruction of predicted values they are placed true to scale with the aid of these quantification steps. Modifying the values of these quantification steps brings about visual deteriorations in the stream. Likewise, modifying the quantification steps transmitted to the decoder to parameterize the enhancement filter brings about a deterioration of the visual quality of the stream.

The principle of scrambling based on these various characteristics will be better understood with the aid of the following non-limiting example.

The figure represents one possible client-server system.

Original stream 1 is directly in digital form or analog form. In this latter instance, the analog stream is converted by a DCT-based coder and using non-represented prediction modes in a digital format 2. The video stream of the H264 type to be secured 2 is passed to analysis and scrambling module 3 that will generate a modified main stream 5 in the format identical to input stream 2 except that certain coefficients have been replaced by values different from the original ones, and is stored in server 6. Complementary information 4 in any format is also placed in server 6 and contains information relative to the elements of the images that were modified, replace, substituted or moved, and to their values or locations in the original stream.

Stream 5 in the identical format of the original stream is then transmitted via a high-throughput network of the microwave (hertzian), cable, satellite type or the like to the terminal of the user 8, and more precisely onto hard disk 10. When user 8 makes a request to view the film present on hard disk 10, two things are possible: either user 8 does not have all the rights necessary to view the film, in which case video stream 5 generated by scrambling module 3 present on hard disk 10 is passed to synthesis system 13 via reading buffer memory 1 1, that does not modify it and transmits it identically to a display reader capable of decoding it 14, and its content, degraded visually by scrambling module 3, is displayed on viewing screen 15. Video stream 5 generated by scrambling module 3 is advantageously passed directly via network 9 to reading buffer memory 11 then to synthesis system 13.

Or, the server decides that user 8 has the rights to correctly view the film, in which case synthesis module 13 makes a viewing request to server 6 containing the complementary information necessary 4 for reconstitution of the original video 2. Server 6 then sends the complementary information 4 via telecommunication network 7 of the analog or digital telephone type, DSL (Digital Subscriber Line) or BLR (local radio loop) type, via DAB (Digital Audio Broadcasting) networks, or via mobile digital telecommunication networks (GSM, GPRS, UMTS), which complementary information permits reconstitution of the original stream in such a manner that user 8 can store it in buffer memory 12. Synthesis module 13 then proceeds to the reconstitution of the original stream from the scrambled video stream that it reads in its reading buffer memory 11, of the modified fields whose positions it recognizes, and the original values are restored by virtue of the content of the complementary information read in descrambling buffer memory 12. Complementary information 4, that is sent to the descrambling module is specific for each user and depends on user rights, for example, single or multiple usage, the right to make one or several private copies, delayed or advance payment.

Modified main stream 5 is passed directly via a network 9 to reading buffer memory 11, then to synthesis module 13.

Modified main stream 5 is recorded on a physical support such as a disk of the CD-ROM type, DVD type, hard disk, flash memory card or the like, 9bis. Modified main stream 5 is then read from physical support 9bis by disk reader 10bis of box 8 to be transmitted to reading buffer memory 11, then to synthesis module 13.

Complementary information 4 is recorded on a physical support 7bis with a credit card format constituted of a smart card, a flash memory card or the like. Card 7bis is read by module 12 of device 8 comprising a card reader 7ter.

Card 7bis advantageously contains applications and algorithms to be executed by synthesis system 13.

Device 8 is advantageously an autonomous, portable and mobile system.

1. A process for secured distribution of video sequences in accordance with a digital stream format based on a DCT transformation having frames comprising blocks with a fixed or variable size, wherein at least a part of the blocks is calculated with temporal prediction and spatial prediction determined from adjacent blocks, in which a prediction mode, cutting into blocks and decoding and filtering parameters for display are identified in a binary stream, comprising analyzing the stream prior to transmission to client equipment to generate a modified main stream with a format of the original stream, and complementary information of any format comprising digital information suitable for allowing reconstruction of modified frames, and transmitting the modified main stream and complementary information separately during a distribution phase from a server to equipment of an addressee.

2. The process in accordance with claim 1, applied to streams in conformity with one of norms H.264, MPEG-4 part 10 or AVC or JVT.

3. The process in accordance with claim 1, wherein scrambling is performed for a stream in conformity with H.264 standard by modifying an indication of spatial prediction modes of intra blocks of I and/or SI frames.

4. The process in accordance with claim 1, wherein scrambling is performed for frames I, P and B by modifying a value of DC and AC coefficients calculated from residues of a prediction prior to entropic coding.

5. The process in accordance with claim 1, wherein scrambling is performed for frames I, P and B by modifying a value of DC and AC coefficients calculated from residues of a prediction after entropic coding.

6. The process in accordance with claim 1, wherein scrambling is performed for P and B frames by modifying an indication for partitions of macroblocks.

7. The process in accordance with claim 1, wherein scrambling is performed by modifying an index of reference images relative to calculation of movement vectors.

8. The process in accordance with claim 1, wherein scrambling is performed by modifying steps of quantifications transmitted in the stream and used for decoding.

9. The process in accordance with claim 1, wherein scrambling is performed by modifying parameters transmitted in the stream and used for decoding and enhancement filter.

10. The process in accordance with claim 1, wherein scrambling is performed by modifying values stemming from an entropic encoding in a binary stream and an original value extracted is replaced by a random or calculated value of the same size.

11. The process for in accordance with claim 1, applied to streams in conformity with MPEG-4 norm, part 2 visual.

12. The process in accordance with claim 11, wherein scrambling is performed by modifying predicted DC and AC coefficients of Intra blocks.

13. The process in accordance with claim 11, wherein scrambling is performed by modifying quantification steps transmitted in the stream and used for decoding and enhancement filter.

14. The process in accordance with claim 1, wherein scrambling generates a modified main stream whose size or throughput rate is the same as the size or to the throughput rate of the original stream.

15. The process in accordance with claim 1, wherein a synthesis of a nominal format stream is calculated on the addressee's equipment as a function of the modified main stream and the complementary information.

16. The process in accordance with claim 15, wherein synthesis of the stream calculated on the addressee's equipment produces a stream the same as the original stream.

17. The process in accordance with claim 1, wherein complementary information is encrypted with one or several known elements of only the user to prevent its use by a third user.

18. The process in accordance with claim 16, wherein the complementary information encrypted with one or several elements of the user is stored temporarily in a secure or non-secure memory to allow its use by the addressed user in a non-connected mode.

19. A system for producing a video stream comprising at least one multimedia server containing original video sequences, a device for analyzing a video stream, a device for separating the original video stream into a modified main stream and complementary information as a function of an analysis, at least one telecommunication network for transmission and at least one device in the addressee's equipment for reconstruction of the video stream as a function of the modified main stream and the complementary information.
